(19) United States
(12) Patent Application Publication
(10) Pub. No.: US 2025/0079432 A1
(43) Pub. Date: Mar. 6, 2025

(54) ZERO TRANSITION ELECTRODE COATING

(71) Applicant: Apple Inc., Cupertino, CA (US)

(72) Inventors: Daeshin Lee, San Jose, CA (US); Joshua M. Chien, San Mateo, CA (US); Rajesh Kandibanda, Los Gatos, CA (US); Mark E. Wilcox, Morgan Hill, CA (US)

(21) Appl. No.: 18/956,590

(22) Filed: Nov. 22, 2024

Related U.S. Application Data
(62) Division of application No. 17/691,681, filed on Mar. 10, 2022.
(60) Provisional application No. 63/159,682, filed on Mar. 11, 2021.

(51) Int. Cl. H01M 4/04; H01M 4/02; H01M 10/04

(52) U.S. Cl. CPC H01M 4/0404; H01M 10/0436; H01M 2004/021; H01M 2220/30

(57) ABSTRACT

The disclosed technology relates to manufacturing a battery cell. Manufacturing the battery cell can include applying a mask onto a first surface of a current collector, coating the first surface of the current collector with an active coating, removing the mask from the first surface of the current collector, stamping the current collector to form an anode layer with an uncoated tab, and arranging a stacked set of layers within an enclosure, such that the stacked set of layers comprise a cathode layer, the anode layer, and a separator layer disposed between the cathode layer and the anode layer.

### PRIORITY

This application is a divisional of U.S. application Ser. No. 17/691,681, filed Mar. 10, 2022, which claims the benefit of U.S. Provisional Patent Application No. 63/159,682, filed on Mar. 11, 2021, each of which is incorporated herein by reference in its entirety.

### TECHNICAL FIELD

The present disclosure relates generally to battery cells, and more particularly, to battery cells having electrodes with a zero transition profile.

### BACKGROUND

Battery cells are used to provide power to a wide variety of portable electronic devices, including laptop computers, tablet computers, mobile phones, personal digital assistants (PDAs), digital music players, watches, and wearable devices. A commonly used type of battery is a lithium battery, which can include a lithium-ion or a lithium-polymer battery.

Lithium batteries often include cells that are made of an anode layer and a cathode layer, with a separator disposed there-between. The layers may stacked or wound, and may be housed within a pouch or an enclosure. A first conductive tab may be coupled to the cathode layer and a second conductive tab may be coupled to the anode layer. The first and second conductive tabs may extend through the pouch or enclosure to provide terminals for the battery cell.

### SUMMARY

In some embodiments, a method for manufacturing a battery cell is disclosed. The method can include applying a mask onto a first surface of a current collector, coating the first surface of the current collector with an active coating, removing the mask from the first surface of the current collector, stamping the current collector to form an anode layer with an uncoated tab, and arranging a stacked set of layers within an enclosure. The active coating of the anode layer has a transition profile in a neck region of the uncoated tab. The transition profile has an angle greater than 60°. The stacked set of layers comprise a cathode layer, the anode layer, and a separator layer disposed between the cathode layer and the anode layer.

In some embodiments, a battery cell is disclosed. The battery cell can include a stacked set of layers comprising a cathode layer, an anode layer, and a separator layer disposed between the cathode layer and the anode layer, and an enclosure enclosing the stacked set of layers. The anode layer can include a current collector, an active coating disposed on a first surface of the current collector, and an uncoated tab. The active coating on the first surface has a transition profile in a neck region of the uncoated tab. The transition profile of the active coating on the first surface has an angle greater than 60°.

In some embodiments, a portable electronic device is disclosed. The portable electronic device can include a set of components powered by a battery and an enclosure enclosing the stacked set of layers. The battery can include a stacked set of layers comprising a cathode layer, an anode layer, and a separator layer disposed between the cathode layer and the anode layer. The anode layer comprises a current collector, an active coating disposed on a first surface of the current collector, and an uncoated tab. The active coating on the first surface has a transition profile in a neck region of the uncoated tab. The transition profile of the active coating on the first surface has an angle greater than 60°.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a partial cross section of a prior art electrode, in accordance with illustrative embodiments of the disclosure;

FIG. 2 illustrates a partial cross section of an electrode having a current collector with masks and coatings applied thereon, in accordance with various embodiments of the subject technology, in accordance with illustrative embodiments of the disclosure;

FIG. 3 illustrates a partial cross section of the current collector after removal of the masks, in accordance with various embodiments of the subject technology, in accordance with illustrative embodiments of the disclosure;

FIG. 4 illustrates a top view of a prior art electrode stack demonstrating a battery assembly having an anode tab and a cathode tab, in accordance with illustrative embodiments of the disclosure;

FIG. 5 illustrates a top view of a battery assembly having an anode tab and a cathode tab, in accordance with various embodiments of the subject technology, in accordance with illustrative embodiments of the disclosure;

FIG. 6 illustrates a current collector prior to application of masks, in accordance with illustrative embodiments of the disclosure;

FIG. 7 illustrates a current collector with masks applied thereon, in accordance with illustrative embodiments of the disclosure;

FIG. 8 illustrates a current collector with a coating applied over the masks applied on the current collector, in accordance with illustrative embodiments of the disclosure;

FIG. 9 illustrates a current collector after the masks are removed, in accordance with illustrative embodiments of the disclosure;

FIG. 10 illustrates a current collector slitted and stamped to form one or more anode and/or cathodes layers, in accordance with illustrative embodiments of the disclosure;

FIG. 11 illustrates a cross-section view of a battery, in accordance with various embodiments of the subject technology, in accordance with illustrative embodiments of the disclosure;

FIG. 12 illustrates a portable electronic device, in accordance with various embodiments of the subject technology, in accordance with illustrative embodiments of the disclosure; and

FIG. 13 is a flowchart of an example method for manufacturing a battery, in accordance with illustrative embodiments of the disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Conventionally, anode active coatings disposed on substrates or current collectors have low viscosity resulting in the anode active material flowing to uncoated portions of the current collector. The region onto which the anode active material flows is typically referred to as a transition zone. Because of the low viscosity of the anode active material, conventional anodes have a transition zone that at one end, comprises a thinned application of the anode active coating, and at the opposite end, comprises a thicker application of the anode active coating. The varying thickness of the anode active coating can lead to a poor interface between the active coating the current collector, which in turn can lead to failure of the active coating. In addition, because the conventional transition zone occupies physical space on the current collector due to viscous nature of the anode active coating, valuable space is occupied leading to lower battery and packaging efficiencies.

The disclosed technology addresses the need for improving the interface between active coatings and current collectors to prevent failures and improve battery and packaging efficiencies by implementing a zero transition profile for the active coating. The zero transition profile improves the interface between the active coating and the current collector and the battery and packaging efficiency of such batteries by eliminating the conventional active coatings transitions exhibited on conventional batteries.

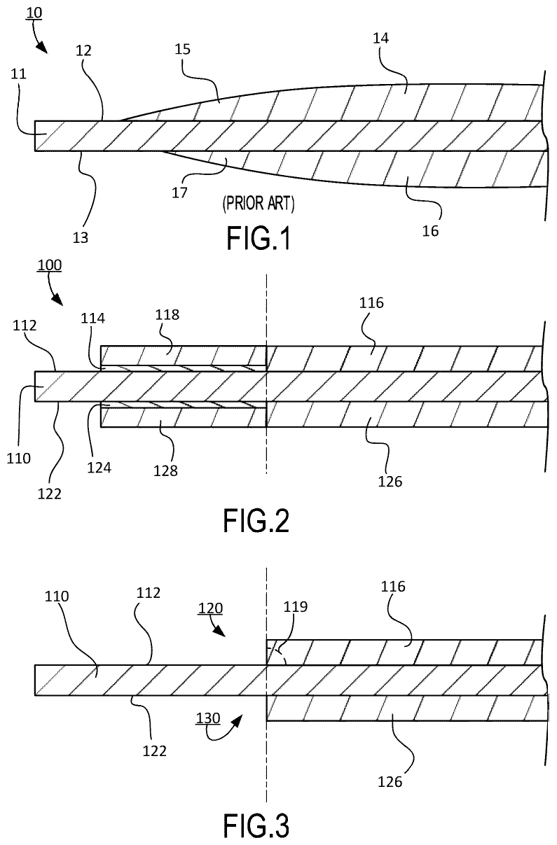

FIG. 1 illustrates a partial cross section of a prior art electrode 10 having a current collector 11 with coatings 14, 16 applied thereon. As shown, current collector 11 has a first side 12 and a second side 13. Coatings 14, 16 are applied on first side 12 and second side 13, respectively. Furthermore, coatings 14, 16 respectively, have transitions zones 15, 17 as coatings 14, 16 extend towards a distal end of current collector 11.

Transition zones 15, 17 is caused by the viscous nature of the coatings 14, 16, which when applied, are done so in a slurry form resulting in a tapering of the coatings 14, 16 proximate to the distal end of the current collector 11. Transition zones 15, 17 can cause swelling of the coatings 14, 16 due to poor interface between the coatings 14, 16 and the current collector 11 at the transition zones 15, 17. Furthermore as shown, transition zones 15, 17 comprise non-uniform areas of coatings 14, 16 that not only have varying thicknesses when compared to other areas of the coatings 14, 16 (e.g., area away from the distal end of current collector 11 shown in FIG. 1), but further have varying lengths as demonstrated by the coating 14 disposed on the first side 12 extending closer to the distal end of the current collector 11 than the coating 16 disposed on the second side 13. The non-uniformity of transition zones 15, 17 is conventionally remedied by allowing for a larger margin of error in manufacturing, which then translates to requiring more physical space in a battery to accommodate such margin which further leads to inefficiencies in battery capacity and packaging volume. Additionally, the non-uniformity of transition zones 15, 17 can cause insufficient and/or non-ideal areal capacity ratios of negative to positive electrodes (N—P ratio), which can cause non-optimized performance of a resulting battery cell. More specifically, the N—P ratio is an important factor for optimizing batteries with high performance due to the balance of electrochemical reactions that output energy from the battery to a device utilizing the battery.

FIG. 2 illustrates a partial cross section of an electrode 100 having a current collector 110 with masks and coatings applied thereon, in accordance with various embodiments of the subject technology. Current collector 110 can have a first surface 112 and a second surface 122 with coatings 116, 126 applied respectively over surfaces 112, 122. More specifically, first surface 112 can have a first mask 114 cover a portion of first surface 112. An active coating (e.g., coating 116) can be applied on first surface 112, such that a portion 118 of the active coating can also be applied over first mask 114. Similarly, second surface 122 can have a second mask 124 cover a portion of second surface 122. An active coating (e.g., coating 126) can be applied on second surface 122, such that a portion 128 of the active coating can also be applied over mask 124. Coating 116 and coating 126 can be a lithium compound (e.g., LiCoO₂, LiNCoMn, LiCoAl or LiMn₂O₄) for a cathode. Similarly, coating 116 and coating 126 can be carbon or graphite for an anode.

Masks 114, 124 can be removably attached onto current collector 110. Thus, after application of coatings 116, 126, masks 114, 124 can be removed from current collector 110 to remove the portions 118, 128 of coatings 116, 126 that was applied on masks 114, 124.

In some embodiments, masks 114, 124 can be polyimide tape to mask portions of current collector 110 from coatings 116, 126. However, it is to be understood, that other removable mask materials can be used without departing from the scope of the disclosure. In other embodiments, the portions 118, 128 of coatings 116, 126 may be removed via abrasion or other mechanical processes that a person of ordinary skill in the art would understand could be affectively applied to remove portions 118, 128 from current collector 110, such as through the use of laser ablation or photoablation.

FIG. 3 illustrates a partial cross section of the current collector 110 after removal of masks 114, 124, in accordance with various embodiments of the subject technology. As shown, coatings 116, 126 no longer have portions 118, 128 disposed on current collector 110. Instead, a first transition profile 120 on first surface 112 and a second transition profile 130 on second surface 122 is now present. Transition profiles 120, 130 are adjacent to areas of the current collector 110 that do not have coatings 116, 126. As shown, compared to conventional transition zones 15, 17 (as shown in FIG. 1), the transition profiles 120, 130 have no gradual transition. More specifically, transition profiles 120, 130 comprise a sharp angle or zero transition. For example, transition profile 120 on first surface 112 has an angle 119 defined as the angle between the first surface 112 and an edge of coating 116 applied on first surface 112. In one aspect, angle 119 can be orthogonal, or perpendicular, to first surface 112. In other aspects, the angle 119 may be an acute angle having a range of 60°-90°. In yet another aspect, the angle 119 may be an obtuse angle having a range of 90°-120°. In yet another aspect, the angle 119 may be any angle between 60° and 120°. In other words, coating 116 defines a clean edge with respect to first surface 112 of current collector 110 and occupies little to no space on the current collector 110.

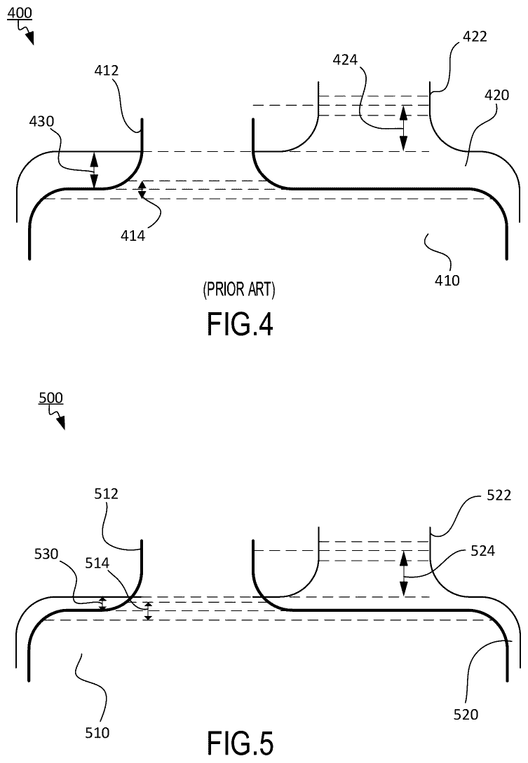

FIG. 4 illustrates a top view of a prior art electrode stack demonstrating a battery assembly 400 having an anode tab and a cathode tab. Battery assembly 400 has a cathode 410 and an anode 420.

Cathode 410 has a cathode tab 412. Cathode distance 414 identifies a transition zone (e.g., transition zone 15 of FIG. 1). As discussed above, the transition zone (i.e., cathode distance 414) may be an area of non-uniform distribution of an active coating. Thus, cathode distance 414 identifies an area that may be prone to swelling and/or cause a poor N—P ratio.

Anode 420 has an anode tab 422. Anode distance 424 identifies a transition zone (e.g., transition zone 15 of FIG. 1). As discussed above, the transition zone (i.e., anode distance 424) may be an area of non-uniform distribution of an active coating. Thus, anode distance 424 identifies an area that may be prone to swelling and/or cause a poor N—P ratio.

An anode-cathode overhang 430 is identified by the distance between an edge of cathode 410 and an edge of anode 420. Anode-cathode overhang 430 of the prior art is generally far apart with a large margin of error to compensate for non-uniform application of the active coatings disposed on the cathode 410 and the anode 420 (as shown in FIG. 1) in the transition zone. For example, anode-cathode overhang 430 of the prior art is generally approximately 0.87 mm with an acceptable margin of error of 0.45 mm. Furthermore, anode-cathode overhang 430 of the prior art is further constrained by limited cathode sizing to ensure a desirable N—P ratio.

FIG. 5 illustrates a top view of a battery assembly 500 having an anode tab and a cathode tab, in accordance with various embodiments of the subject technology. Battery assembly 500 has a cathode 510 and an anode 520.

Cathode 510 has a cathode tab 512. Cathode distance 514 identifies what would be the non-uniform transition zone of the prior art (as described above with reference to FIG. 4). However, due to the technologies disclosed herein, cathode distance 514 has uniform distribution of the coating. Thus, there is no area of non-uniformity or gradual deposit region at the edge of the transition profile. As shown in FIG. 3, the transition zone has a substantially straight or right-angle profile thereby reducing an amount of space occupied by the cathode active coating on the current collector.

Anode 520 has an anode tab 522. Anode distance 524 identifies what would be the non-uniform transition zone of the prior art (as described above with reference to FIG. 4). However, due to the technologies disclosed herein, anode distance 524 has uniform distribution of the coating. Thus, there is no area of non-uniformity or gradual deposit region at the edge of the transition profile. As shown in FIG. 3, the transition zone has a substantially straight or right-angle profilethereby reducing an amount of space occupied by the anode active coating on the current collector.

Because of the reduction of space occupied by the transition zone, an anode-cathode overhang 530, identified by the distance between an edge of cathode 510 and an edge of anode 520, is significantly reduced thereby achieving a higher level of precision and accuracy and allowing for a smaller margin of error. For example, anode-cathode overhang 530 can be as small as 0.76 mm with an acceptable margin of error of 0.39 mm. Additionally, due to the additional precision and accuracy, the size of the cathode can be increased, which allows for higher volumetric energy density of the overall cell.

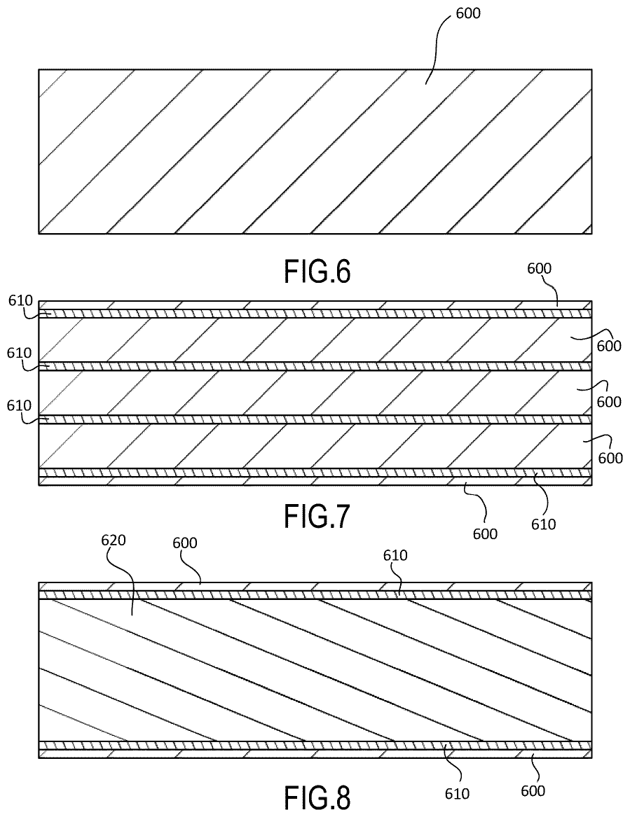

FIGS. 6-10 illustrate a process for manufacturing the electrodes of the subject technology where an active coating disposed on their corresponding current collectors exhibit a zero transition profile. FIG. 6 illustrates a current collector 600 prior to application of masks and active coatings.

FIG. 7 illustrates the current collector 600 with masks 610 applied thereon. As discussed above, masks 610 can be removably attached onto current collector 600, so that when masks 610 are removed from current collector 600, any materials applied onto masks 610 can also be removed.

FIG. 8 illustrates current collector 600 with a coating 620 applied over masks 610 and over the current collector 600. More specifically, at least a portion of coating 620 is applied onto masks 610, while at least another portion is applied directly onto current collector 600.

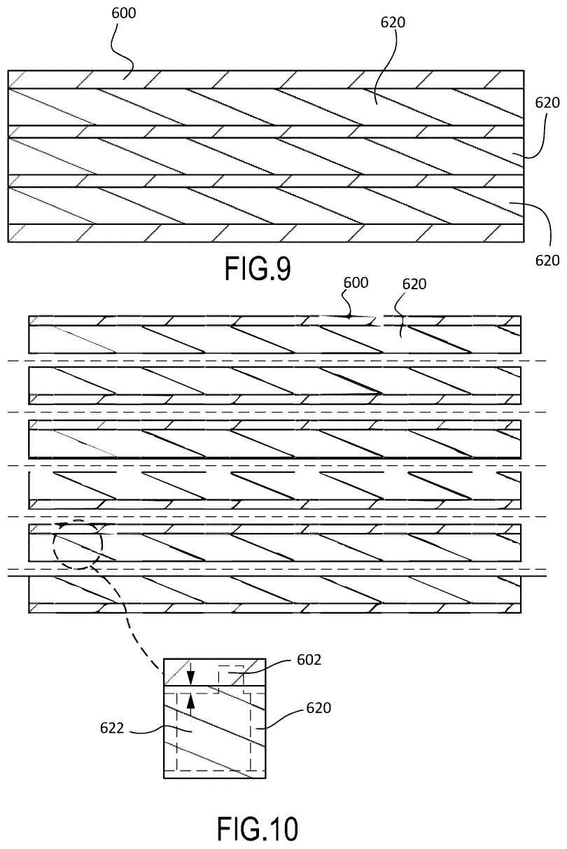

FIG. 9 illustrates current collector 600 after masks 610 are removed. As illustrated, the removal of masks 610 results in straight or clean edges with uniform distribution of coating 620 onto the current collector 600. Notably, the resulting transition profiles of the coating 620 at junctions where the coating 620 and current collector 600 meet, exhibit a zero transition zone—that is—an angle between the coating 620 and the current collector is a right angle, or is substantially a right angle having an angle, for example, of 60°-120°.

FIG. 10 illustrates current collector 600 slitted and stamped to form one or more anodes and/or cathodes. In some embodiments, current collector 600 is slit along portions where masks 610 was removed from. The results are strips of current collectors 600 with coatings 620 with no or zero transition zones.

Additionally, portions 622 of current collector 600 can be stamped to form anodes and/or cathodes. In some embodiments, portions 622 can be stamped to also form tabs 602, such that at least a portion of tab 602 is uncoated and free of coating 620, while another portion of tab 602 has a uniform coating 620 at or near an edge of tab 602 that extends from the coated region of the current collector. In other words, portions 622 of current collector 600 can be stamped to form anodes and/or cathodes with uncoated tabs. Additionally, the transition profiles of the coating 620 at junctions where the coating 620 and current collector 600 meet, exhibit a zero transition zone—that is—an angle between the coating 620 and the current collector is a right angle, or is substantially a right angle having an angle, for example, of 60°-120°.

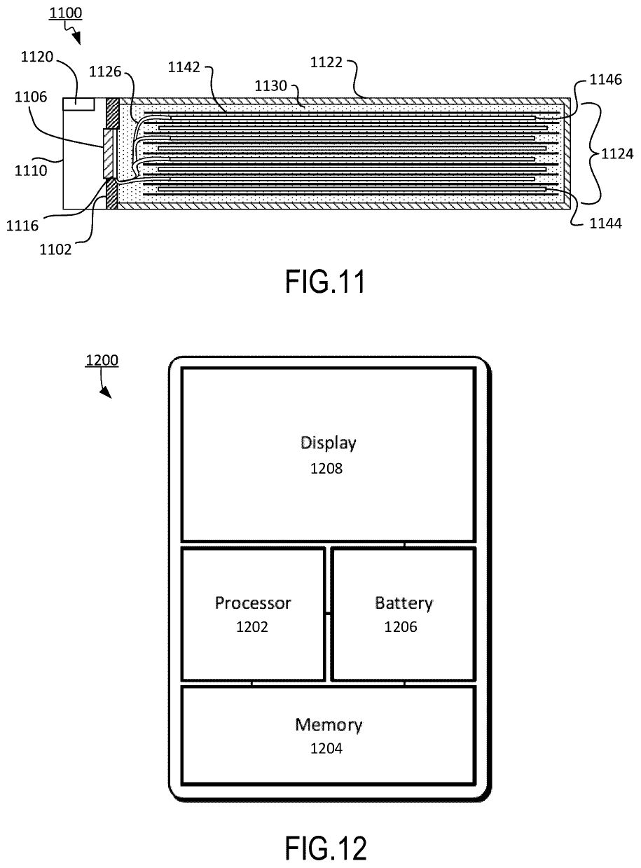

FIG. 11 illustrates a cross-section view of an assembled battery 1100, in accordance with various aspects of the subject technology. The assembled battery 1100 includes the battery cell 1100, an enclosure 1122, a feedthrough 1106 extending through an opening 1116 at an end 1102 of the enclosure 1122, a battery management unit 1110, and battery terminals 1120. The battery management unit 1110 is configured to manage recharging of the battery cell 1100. The terminals 1120 are configured to engage with corresponding connectors on a portable electronic device to provide power to components of the portable electronic device.

The battery cell 1100 includes a set of layers 1124 comprising a cathode 1144 with an active coating, a separator 1142, and an anode 1146 with an active coating. For example, the cathode 1144 may be an aluminum foil coated with a lithium compound (e.g., LiCoO₂, LiNCoMn, LiCoAl or LiMn₂O₄) and the anode 1146 may be a copper foil coated with carbon or graphite. The separator 1142 may include polyethylene (PE), polypropylene (PP), and/or a combination of PE and PP, such as PE/PP or PP/PE/PP. The separator 1142 comprises a micro-porous membrane that also provides a “thermal shut down” mechanism. If the battery cell reaches the melting point of these materials, the pores shut down which prevents ion flow through the membrane.

The set of layers 1124 may be wound to form a jelly roll structure or can be stacked to form a stacked-cell structure. The set of layers 1124 are enclosed within enclosure 1122 and immersed in an electrolyte 1130, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The anode layers 1146 of the set of layers 1124 may be coupled to the enclosure 1122 or may be coupled to a feedthrough via a tab (not shown) extending from the anode layers 1146. The cathode layers 1144 of the set of layers 1124 may be coupled to the feedthrough 1106 via one or more tabs 1126 extending from each cathode layer 1144.

FIG. 12 illustrates a portable electronic device 1200, in accordance with various embodiments of the subject technology. The above-described battery can generally be used in any type of electronic device. For example, FIG. 12 illustrates a portable electronic device 1200 which includes a processor 1202, a memory 1204 and a display 1208, which are all powered by the battery 1206. Portable electronic device 1200 may correspond to a laptop computer, tablet computer, mobile phone, personal digital assistant (PDA), digital music player, watch, and wearable device, and/or other type of battery-powered electronic device. Battery 1206 may correspond to a battery pack that includes one or more battery cells.

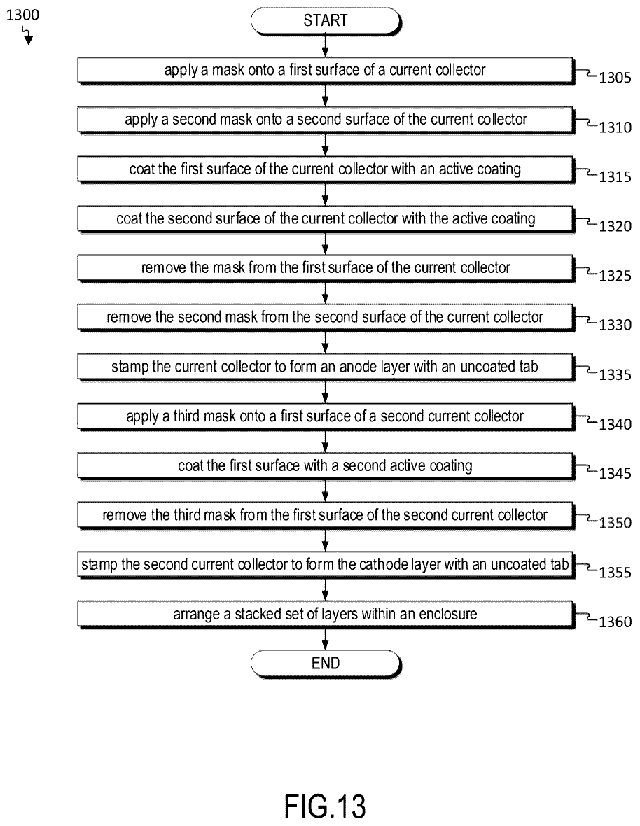

FIG. 13 illustrates an example method 1300 for manufacturing a battery having cathode and anode layers with zero transition profiles. Although the example method 1300 depicts a particular sequence of operations, the sequence may be altered without departing from the scope of the present disclosure. For example, some of the operations depicted may be performed in parallel or in a different sequence that does not materially affect the function and/or outcome of the method 1300. In other examples, different components of an example device or system that implements the method 1300 may perform functions at substantially the same time or in a specific sequence.

According to some embodiments, the method includes applying a mask onto a first surface of a current collector at step 1305.

According to some embodiments, the method includes applying a second mask onto a second surface of the current collector at step 1310. The second surface is disposed opposite of the first surface. In some embodiments, the first mask and the second mask are applied simultaneously. In some embodiments, the second mask applied on the second surface is aligned with the first mask applied on the first surface, as shown in FIGS. 2 and 3.

According to some embodiments, the method includes coating the first surface of the current collector with an active coating at step 1315.

According to some embodiments, the method includes coating the second surface of the current collector with the active coating at step 1320.

According to some embodiments, the method includes removing the mask from the first surface of the current collector at step 1325. In some embodiments, removing the mask creates the angle of the transition profile.

According to some embodiments, the method includes removing the second mask from the second surface of the current collector at step 1330. In one aspect the first mask and the second mask may be removed from the current collection simultaneously.

According to some embodiments, the method includes stamping the current collector to form an anode layer with an uncoated tab at step 1335. In some embodiments, the active coating of the anode layer has a transition profile in a neck region of the uncoated tab. In some embodiments, the transition profile has an angle greater than 60°.

According to some embodiments, the method includes applying a third mask onto a first surface of a second current collector at step 1340. The method may further include applying a fourth mask onto a second surface of the second current collector. The second surface of the second current collector is disposed opposite of the first surface of the second current collector. In some embodiments, the third mask and the fourth mask are applied simultaneously. In some embodiments, the fourth mask applied on the second surface of the second current collector is aligned with the third mask applied on the first surface of the second current collector.

According to some embodiments, the method includes coating the first surface of the second current collector and coating the second surface of the second current collector with a second active coating at step 1345.

According to some embodiments, the method includes removing the third mask from the first surface of the second current collector at step 1350 and removing the fourth mask from the second surface of the second current collector. In some embodiments, the second active coating of the cathode layer has a transition profile in a neck region of the uncoated tab. In some embodiments, the transition profile of the second active coating has an angle greater than 60°.

According to some embodiments, the method includes stamping the second current collector to form the cathode layer with an uncoated tab at step 1355.

According to some embodiments, the method includes arranging a stacked set of layers within an enclosure at step 1360. In some embodiments, the stacked set of layers comprise a cathode layer, the anode layer, and a separator layer disposed between the cathode layer and the anode layer. In some embodiments, the stacked set of layers comprise a cathode layer, the anode layer, and a separator layer disposed between the cathode layer and the anode layer. In some embodiments, an edge of the cathode layer is offset from an edge of the anode layer by a distance of 0.8 mm or less when the stacked set of layers are arranged within the enclosure.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for manufacturing a battery cell, the method comprising:
applying a mask onto a first surface of a current collector;
coating the first surface of the current collector with an active coating;
removing the mask from the first surface of the current collector;
stamping the current collector to form an anode layer with an uncoated tab;
wherein the active coating of the anode layer has a transition profile in a neck region of the uncoated tab;
wherein the transition profile has an angle greater than 60°; and
arranging a stacked set of layers within an enclosure, wherein the stacked set of layers comprise a cathode layer, the anode layer, and a separator layer disposed between the cathode layer and the anode layer.

2. The method of claim 1, wherein removing the mask creates the angle of the transition profile.

3. The method of claim 1, further comprising:
applying a second mask onto a second surface of the current collector.

4. The method of claim 3, wherein the first mask and the second mask are applied simultaneously.

5. The method of claim 3, wherein the second mask applied on the second surface is aligned with the first mask applied on the first surface.

6. The method of claim 3, further comprising:
coating the second surface of the current collector with the active coating; and
removing the second mask from the second surface of the current collector.

7. The method of claim 6, further comprising:
applying a third mask onto a first surface of a second current collector;
coating the first surface of the second current collector with a second active coating;
removing the third mask from the first surface of the second current collector; and
stamping the second current collector to form the cathode layer with an uncoated tab,
wherein the second active coating of the cathode layer has a transition profile in a neck region of the uncoated tab, and
wherein the transition profile of the second active coating has an angle greater than 60°.

8. The method of claim 7, wherein an edge of the cathode layer is offset from an edge of the anode layer by a distance of 0.8 mm or less when the stacked set of layers are arranged within the enclosure.

9. A battery cell comprising:
a stacked set of layers comprising a cathode layer, an anode layer, and a separator layer disposed between the cathode layer and the anode layer;
wherein the anode layer comprises a current collector, an active coating disposed on a first surface of the current collector, and an uncoated tab;
wherein the active coating on the first surface has a transition profile in a neck region of the uncoated tab;
wherein the transition profile of the active coating on the first surface has an angle greater than 60°; and
an enclosure enclosing the stacked set of layers.

10. The battery cell of claim 9, wherein the anode layer further comprises the active coating disposed on a second surface of the current collector, the second surface opposite the first surface; wherein the active coating on the second surface has a transition profile in the neck region of the uncoated tab; and wherein the transition profile of the active coating on the second surface has an angle greater than 60°.

11. The battery cell of claim 10, wherein the transition profile of the active coating on the first surface is aligned with the transition profile of the active coating on the second surface.

12. The battery cell of claim 9, wherein the cathode layer comprises a second current collector, a second active coating disposed on a first surface of the second current collector, and a second uncoated tab; wherein the second active coating on the first surface of the second current collector has a transition profile in a neck region of the second uncoated tab; wherein the transition profile of the second active coating on the first surface of the second current collector has an angle greater than 60°.

13. The battery cell of claim 12, wherein the cathode layer further comprises the second active coating disposed on a second surface of the second current collector, the second surface of the second current collector opposite the first surface of the second current collector; wherein the second active coating on the second surface of the second current collector has a transition profile in the neck region of the second uncoated tab; and wherein the transition profile of the second active coating on the second surface of the second current collector has an angle greater than 60°.

14. The battery cell of claim 13, wherein the transition profile of the second active coating on the first surface of the second current collector is aligned with the transition profile of the second active coating on the second surface of the second current collector.

15. The battery cell of claim 9, wherein an edge of the cathode layer is offset from an edge of the anode layer by a distance of 0.8 mm or less when the stacked set of layers are arranged within the enclosure.

16. A portable electronic device comprising:
a set of components powered by a battery;
the battery comprising:
a stacked set of layers comprising a cathode layer, an anode layer, and a separator layer disposed between the cathode layer and the anode layer;
wherein the anode layer comprises a current collector, an active coating disposed on a first surface of the current collector, and an uncoated tab,
wherein the active coating on the first surface has a transition profile in a neck region of the uncoated tab,
wherein the transition profile of the active coating on the first surface has an angle greater than 60°, and
an enclosure enclosing the stacked set of layers.

17. The portable electronic device of claim 16, wherein the anode layer further comprises the active coating disposed on a second surface of the current collector, the second surface opposite the first surface; wherein the active coating on the second surface has a transition profile in the neck region of the uncoated tab; and wherein the transition profile of the active coating on the second surface has an angle greater than 60°.

18. The portable electronic device of claim 17, wherein the transition profile of the active coating on the first surface is aligned with the transition profile of the active coating on the second surface.

19. The portable electronic device of claim 16, wherein the cathode layer comprises a second current collector, a second active coating disposed on a first surface of the second current collector, and a second uncoated tab; wherein the second active coating on the first surface of the second current collector has a transition profile in a neck region of the second uncoated tab; wherein the transition profile of the second active coating on the first surface of the second current collector has an angle greater than 60°.

20. The portable electronic device of claim 16, wherein an edge of the cathode layer is offset from an edge of the anode layer by a distance of 0.8 mm or less when the stacked set of layers are arranged within the enclosure.
